(19) United States
(12) Patent Application Publication
(10) Pub. No.: US 2007/0101261 A1
(43) Pub. Date: May 3, 2007

(54) System and method for dynamic model-driven transformations

(75) Inventors: Kevin Edward Kelly, Raleigh, NC (US); Jan Joseph Kratky, Raleigh, NC (US); Steven Keith Speicher, Apex, NC (US); Keith Allen Wells, Angier, NC (US)

Correspondence Address: VAN LEEUWEN & VAN LEEUWEN, P.O. BOX 90609, AUSTIN, TX, 78709-0609, US

(73) Assignee: International Business Machines Corporation

(21) Appl. No.: 11/251,239

(22) Filed: Oct. 14, 2005

(51) Int. Cl. G06F 17/00; G06F 9/45

(52) U.S. Cl. 715/523; 715/530; 715/511; 717/138

(57) ABSTRACT

A system and method for using a transformation engine to dynamically transform source instance document changes to target instance document changes is presented. A mapping developer creates and stores “model mapping definitions” that map source model elements to target model elements. In turn, the transformation engine receives source instance document changes from a user, and identifies the model mapping definition that corresponds to the changes. The transformation engine analyzes the model mapping definition, and locates a transformer that is defined in the model mapping definition. As a result, the transformation engine uses the transformer to generate a target object based upon the changes to the source instance document. The target object is inserted into a target instance document, which the user views.

### BACKGROUND OF THE INVENTION

1. Technical Field

The present invention relates to a system and method for dynamic model-driven transformations. More particularly, the present invention relates to a system and method for using a transformation engine to dynamically transform source instance document changes to target instance document changes, and displaying the target instance document changes on a target editor.

2. Description of the Related Art

Many users, such as software developers, business analysts, and database designers, work within a software development environment that enables instance document creation (e.g., data and metadata). In addition, the software development environment typically provides an ability to convert instance documents from one format to another format.

Existing conversion techniques typically convert a “source” instance document that is displayed on a source editor, to a “target” instance document that is displayed on a target editor. For example, a user may use Adobe Distiller to convert a Microsoft Word document to an Adobe Acrobat document. A challenge found with existing art, however, is that a user typically modifies the source instance document multiple times before finalizing the source instance document. Therefore, in order to view the modifications on the target instance document, the user must repeat the conversion routine (e.g., execute Adobe Distiller) each time the source instance document changes.

In addition, the editing, conversion, verification, and correction process are very time-intensive using existing tools. A user may have to repeat many steps in order to finally view a desired target document. As a result, the process results in transformed documents that have lower quality than the original, and typically cost more to produce.

What is needed, therefore, is a system and method to dynamically detect source instance document changes and display corresponding changes on a target instance document.

### SUMMARY

It has been discovered that the aforementioned challenges are resolved using a system and method for using a transformation engine to dynamically transform source instance document changes to target instance document changes, and display the target instance document changes on a target editor. A user uses a model-driven framework as a basis for modifying a source instance document and viewing corresponding changes on a target instance document. The framework, such as Eclipse Modeling Framework (EMF), includes a transformation engine that creates target objects, which are included in a target instance document, based upon changes to a source instance document.

A mapping developer creates and stores model mapping definitions that map source models to target models. For example, the mapping developer may view a source model and a target model using a side-by-side viewer, and select source model elements to associate with target model elements. In one embodiment, the mapping developer may customize the mapping definitions, such as associating a source model element “Name” to two target model elements that are “First Name” and “Last Name.” In addition, the model mapping definition includes information corresponding to a particular transformer for transforming source instance document changes to target instance document changes.

Once the mapping developer completes the model mapping definitions, a user uses a source editor for editing a source instance document, and views corresponding changes to a target instance document on a target editor. For example, the user may edit a Microsoft Word document on the source editor and view a dynamically updated Adobe Acrobat document on the target editor.

When the user adds or modifies content using the source editor, the source editor sends source document input to a transformation engine. For example, the user may add or modify a paragraph to the source instance document. The transformation engine receives the source document input and identifies a source model element that corresponds to the source document input, such as a “paragraph” source model element. In turn, the transformation engine retrieves a model mapping definition that corresponds to the identified source model element.

Once the transformation engine identifies the corresponding model mapping definition, the transformation engine retrieves a transformer that is defined in the model mapping definition. The transformer may be a runtime object that includes metadata such as input model elements, output model elements, and additional transformer attributes.

The transformation engine uses the transformer to generate a target object from the source document input, and display the generated target object on the target editor. For example, the user may create a paragraph using Microsoft Word on the source editor and, in this example, the transformation engine creates an image that includes the paragraph wording to display on the target editor.

In addition, when the transformation engine generates the target object, the transformation engine creates an “object” mapping definition that maps the source object corresponding to the source document input to the generated target object. Therefore, when the user changes the same source object, the transformation engine may use the object mapping definition to update the generated target object.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a user changing a source instance document and a transformation engine generating target objects that are displayed on a target editor;

FIG. 2 is a diagram showing a target instance document dynamically reflecting changes to a source instance document;

FIG. 3 is a flowchart showing steps taken in generating model mapping definitions that associate source models to target models;

FIG. 4 is a high level flowchart showing steps taken in receiving source document input and generating target objects to display on a target editor;

FIG. 5 is a flowchart showing steps taken in generating a target object based upon changes to a source instance document; and

FIG. 6 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

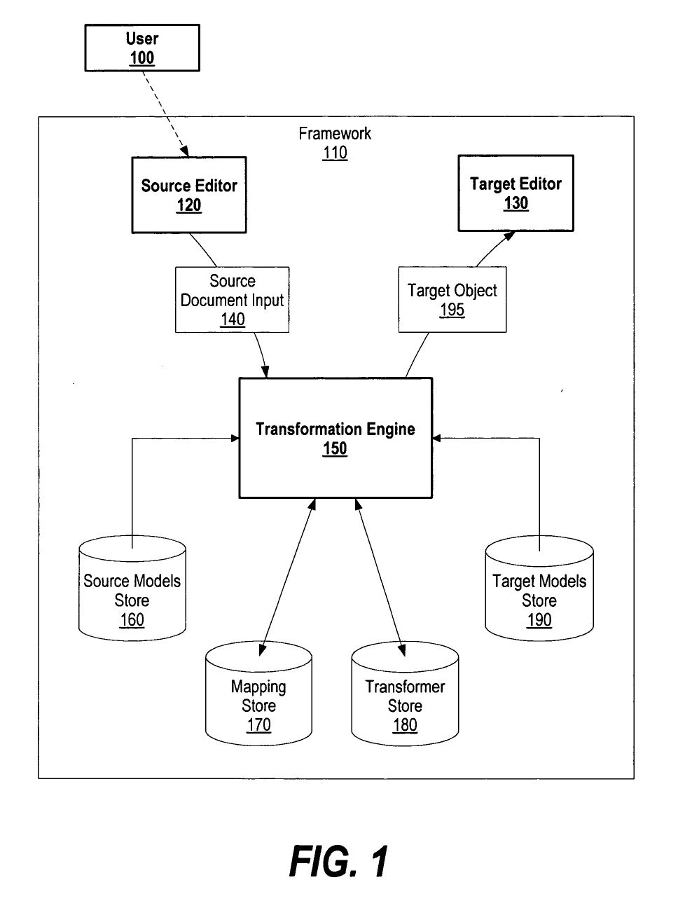

FIG. 1 is a diagram showing a user changing a source instance document and a transformation engine generating target objects that are displayed on a target editor. User 100 uses framework 110 as a basis for modifying a source instance document and viewing corresponding changes on a target instance document. Framework 110, such as Eclipse Modeling Framework (EMF), includes transformation engine 150 that performs dynamic target instance document transformations based upon changes to a source instance document.

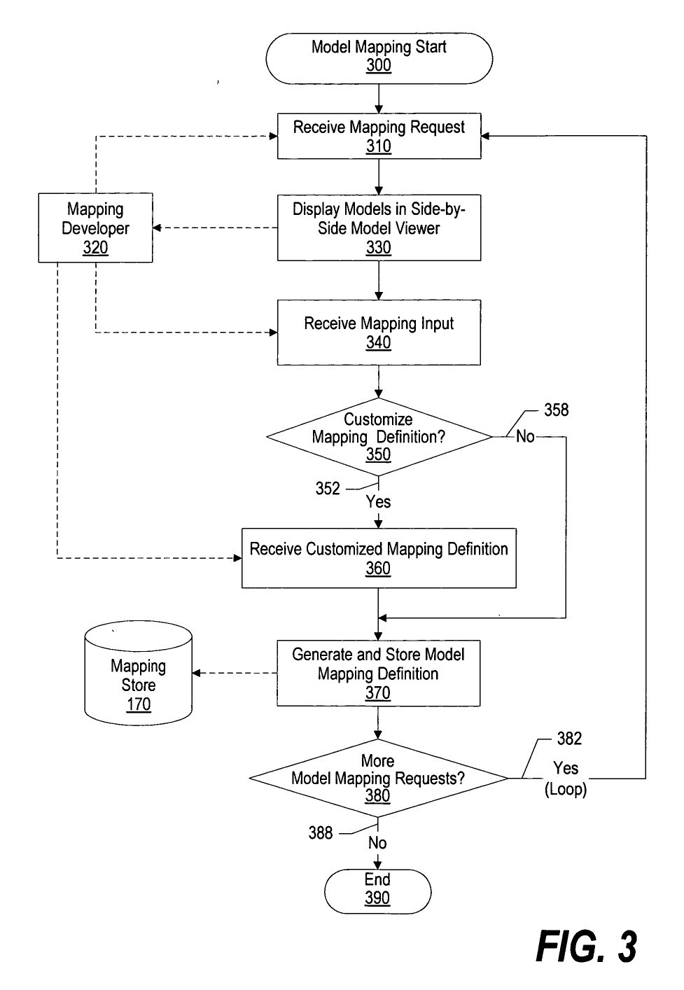

A mapping developer creates and stores model mapping definitions in mapping store 170 that map source model elements located in source models store 160 to target model elements that are located in target models store 190. For example, the mapping developer may view a source model and a target model on a side-by-side viewer, and select source model elements to associate with target model elements. In one embodiment, the mapping developer may customize the mapping definitions, such as associating an element “Name” to two elements that are “First Name” and “Last Name” (see FIG. 3 and corresponding text for further details regarding model mapping definition generation). In addition, the model mapping definition includes information corresponding to a particular transformer for transforming source instance document changes to target instance document changes. Source models store 160, target models store 190, and mapping store 170 may be stored on a nonvolatile storage area, such as a computer hard drive.

Once the mapping developer completes the model mapping definitions, user 100 uses framework 110 to edit a source instance document displayed on source editor 120, and views changes on a target instance document that is displayed on target editor 130. For example, user 100 may edit a Microsoft Word document on source editor 120 and view an Adobe Acrobat document on target editor 130 that reflects the Microsoft Word document, as well as changes to the Microsoft Word document.

When user 100 adds or modifies content using source editor 120, such as modifying a paragraph, source editor 120 sends source document input 140 to transformation engine 150. Transformation engine 150 receives source document input 140 and identifies a source model element in source models store 160 that corresponds to source document input 140, such as a “paragraph” source model element. In turn, transformation engine 150 retrieves a model mapping definition from mapping store 170 that corresponds to the identified source model.

Once transformation engine 150 identifies the corresponding model mapping definition, transformation engine 150 retrieves a transformer from transformer store 180 that is defined in the model mapping definition. The transformer may be a runtime object that includes metadata such as input model elements, output model elements, and additional transformer attributes. Transformer store 180 may be stored on a nonvolatile storage area, such as a computer hard drive.

Transformation engine 150 uses the transformer to generate target object 195 from source document input 140, and display target object 195 on target editor 130. For example, user 100 may create a paragraph using Microsoft Word on source editor 120 and, in this example, transformation engine 150 may create an image that includes the paragraph wording that is displayed on an Adobe Acrobat screen (e.g., target editor 130).

In addition, when transformation engine 150 creates target object 195, transformation engine 150 creates an “object” mapping definition that maps the source object corresponding to source document input 140 to target object 195. Therefore, when user 100 changes the same source object, transformation engine uses the object mapping definition to update target object 195.

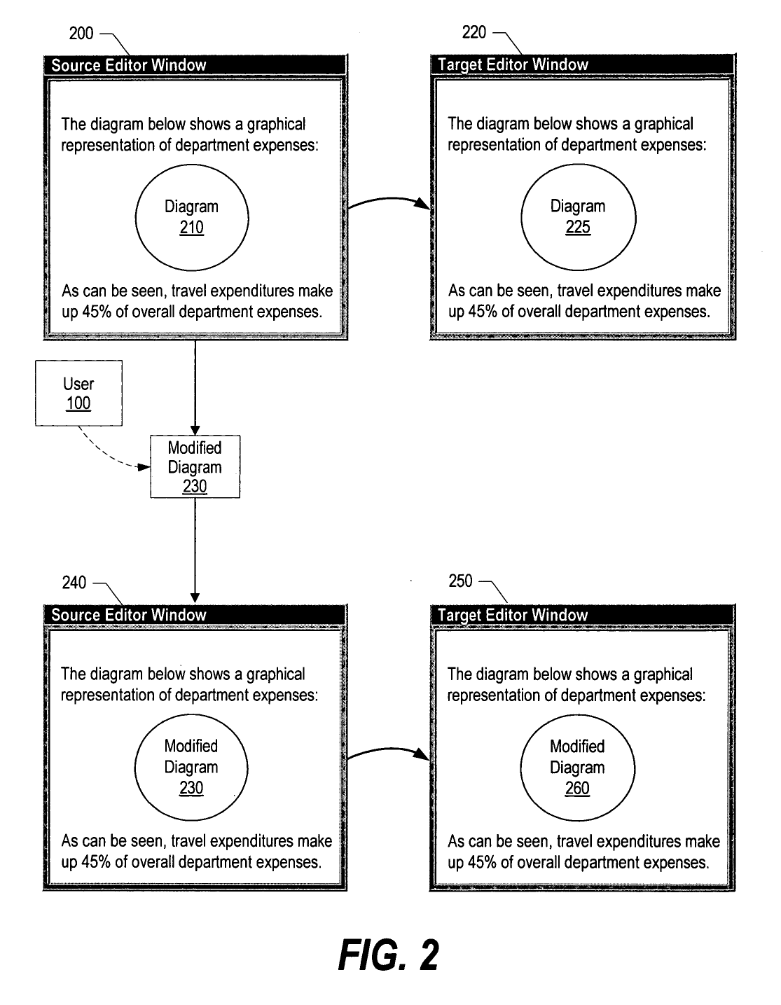

FIG. 2 is a diagram showing a target instance document dynamically reflecting changes to a source instance document. User 100 uses source editor window 200 to modify a source instance document that includes diagram 210. A transformation engine, such as transformation engine 150 shown in FIG. 1, transforms the source instance document into objects that compose a target instance document, which is displayed in target editor window 220. As can be seen, diagram 210 is transformed into target editor window 220 as diagram 225, which is a representation of diagram 210. User 100 is the same as that shown in FIG. 1.

User 100 modifies the source instance document by replacing diagram 210 with modified diagram 230. For example, user 100 may update a pie chart in a financial document with current spending data. As a result, source editor window 240 shows that the source instance document includes modified diagram 230.

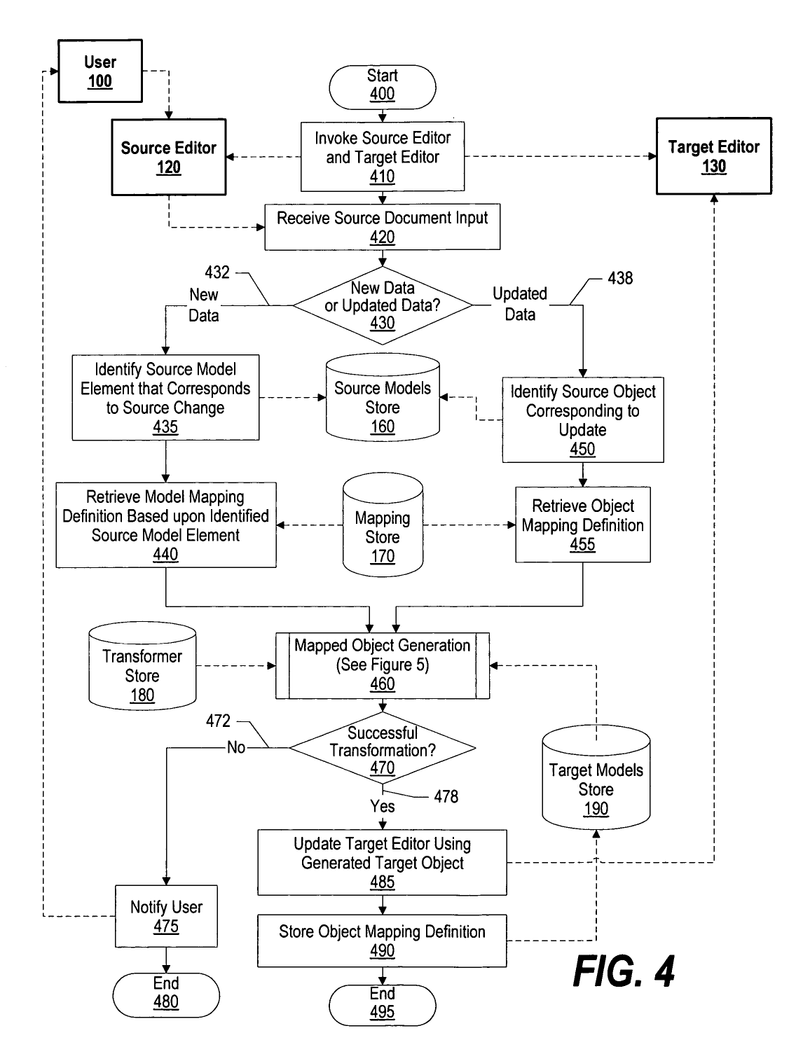

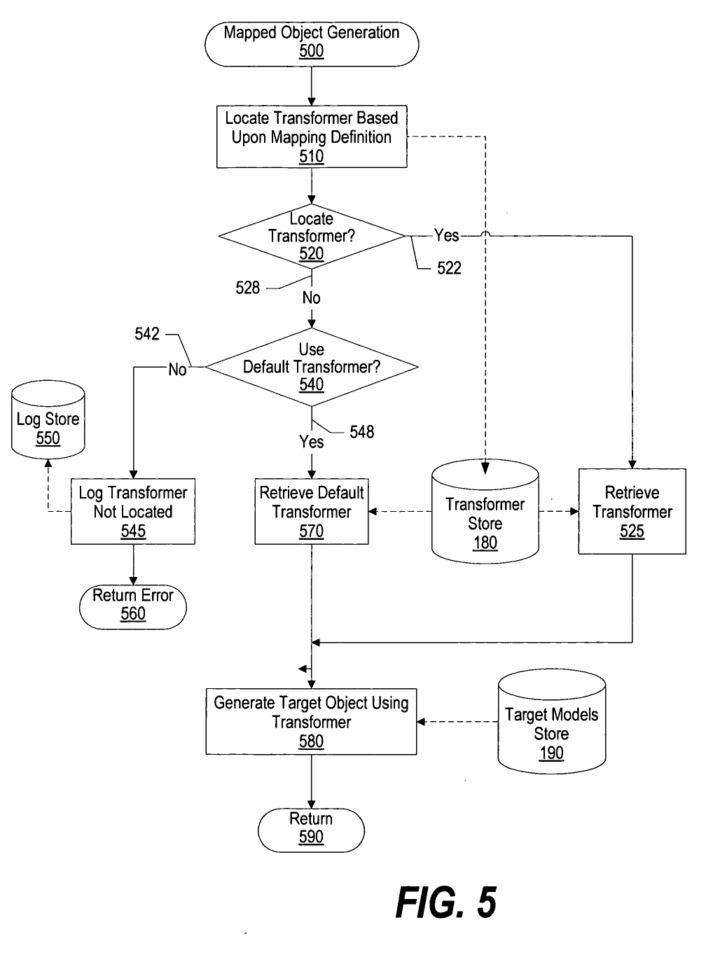

The transformation engine uses a transformer to transform modified diagram 230 to modified diagram 260, which is shown in target editor window 250. During transformation, the transformation engine selectively replaces objects in target editor window 250. For example, the transformation engine replaced diagram 225 with modified diagram 260, but did not replace the text that is positioned before or after diagram 225 (see FIGS. 4, 5, and corresponding text for further details).

FIG. 3 is a flowchart showing steps taken in generating model mapping definitions that associate source models to target models. Processing commences at 300, whereupon processing receives a model mapping request from mapping developer 320 (step 310). Mapping developer 320 wishes to map source models to target models in order for a transformation engine to dynamically transform changes on a source instance document to changes in a target instance document. A framework generates the source instance document from the source models, and generates the target instance document from the target models.

At step 330, processing displays the source models and the target models in a side-by-side model viewer. At step 340, processing receives model mapping input from mapping developer 320 that includes a source model element and a target model element. For example, the model viewer may allow mapping developer 320 to select a particular source model element and a particular target model element, and then select a command button on the model viewer, such as “MAP,” which informs processing to map the source model element to the target model element.

A determination is made as to whether mapping developer 320 wishes to customize the mapping definition (decision 350). For example, a source model may include the element “Name,” while a target model may include elements “First Name” and “Last Name.” In addition, mapping developer 320 may customize the mapping definition by including programming lines, such as Java, XSLT, QVT, etc. for more advanced customizations.

If mapping developer 320 does not wish to customize the mapping definition, decision 350 branches to “No” branch 358 bypassing mapping definition customization steps. On the other hand, if mapping developer 320 wishes to customize the mapping definition, decision 350 branches to “Yes” branch 352, whereupon processing receives the customized mapping definition from mapping developer 320 (step 360).

At step 370, processing generates and stores the model mapping definition in mapping store 170. The generation includes information corresponding to a transformer to use that transforms an instance of the source model element to an instance of the target model element. Mapping store 170 is the same as that shown in FIG. 1. A determination is made as to whether mapping developer 320 has more model mapping requests (decision 380). If mapping developer 320 has more model mapping requests, decision 380 branches to “Yes” branch 382, which loops back to receive and process the next model mapping request. This looping continues until mapping developer 320 does not have any more model mapping requests, at which point decision 380 branches to “No” branch 388. Processing ends at 390.

FIG. 4 is a high level flowchart showing steps taken in receiving source document input and generating target objects to display on a target editor. Processing commences at 400, whereupon processing invokes source editor 120 and target editor 130 (step 410). Source editor 120 displays a source instance document that is generated from source models, and target editor 130 displays a target instance document that is generated from target models.

At step 420, processing receives source document input from source editor 120 in response to user 100's actions. For example, user 100 may modify a particular diagram in a source instance document, or add a new paragraph to the source instance document altogether.

A determination is made as to whether the source document input corresponds to new data or updated data, such as a new paragraph or a modified diagram, respectively (decision 430). If the source document input corresponds to new data, decision 430 branches to “New Data” branch 432 whereupon processing identifies a source model element included in source models store 160 that corresponds to the source document input (step 435). For example, a new paragraph in the source model may correspond to a new ‘text block’ in the target model. Source models store 160 is the same as that shown in FIG. 1.

At step 440, processing retrieves a model mapping definition from mapping store 170 based upon the identified source model element. For example, if the source model element is identified as “srcmdlXYZ,” processing retrieves a model mapping definition that is associated with the source model element “srcmdlXYZ.” Mapping store 170 is the same as that shown in FIG. 1.

If the source document input, however, corresponds to updated data instead of new data, decision 430 branches to “Updated Data” branch 438 whereupon processing identifies a source object located in source models store 160 that corresponds to the source document input (step 450). Since the source document input corresponds to existing data (object), processing receives an object mapping definition from mapping store 170 at step 455. The object mapping definition was previously stored in mapping store 170 when the target object was first generated (see above).

Processing then creates or updates a target object based upon the source document input, the object mapping definition, a transformer located in transformer store 180, and target models that are included in target models store 190 (pre-defined process block 460, see FIG. 5 and corresponding text for further details). Transformer store 180 and target models store 190 are the same as that shown in FIG. 1, and may be stored on a nonvolatile storage area, such as a computer hard drive.

A determination is made as to whether processing performed a successful transformation (decision 470). If the transformation was not successful, decision 470 branches to “No” branch 472 whereupon processing notifies user 100 at step 475, and processing ends at 480. On the other hand, if processing performed a successful transformation, decision 470 branches to “Yes” branch 478 whereupon processing updates the target instance document shown in target editor 130 with the generated target object (step 485). Processing, at step 490, creates and stores an “object” mapping definition in mapping store 170 if one does not yet exist that is similar to the model mapping definition. The object mapping definition maps a source object (paragraph) to a target object (image) as opposed to a model mapping definition that maps one model to another model. Processing ends at 495.

FIG. 5 is a flowchart showing steps taken in generating a target object based upon changes to a source instance document. A user changes a source instance document on a source editor and, in turn, a transformation engine reflects the changes on a target document. Processing commences at 500, whereupon processing locates a transformer located in transformer store 180 based upon the mapping definition that was identified in FIG. 4 (step 510). For example, the transformer may correspond to a utility that converts a Microsoft Word pie chart to a GIF image. Transformer store 180 is the same as that shown in FIG. 1, and may be stored on a nonvolatile storage area, such as a computer hard drive.

A determination is made as to whether processing located the transformer (decision 520). If processing located the transformer, decision 520 branches to “Yes” branch 522 whereupon processing retrieves the transformer from transformer store 180 at step 525.

On the other hand, if processing did not locate the transformer in transformer store 180, decision 520 branches to “No” branch 528 whereupon a determination is made as to whether processing may use a default transformer (decision 540). For example, there may exist a high-level name-based mapping definition, such as a ‘paragraph’ model element that is mapped to a ‘text block’ model element because both are string-based values. If processing is not able to use a default transformer, decision 540 branches to “No” branch 542 whereupon processing logs a “transformer not located” message in log store 550, and returns an error at 560. On the other hand, if processing may use a default transformer, decision 540 branches to “Yes” branch 548 whereupon processing retrieves a default transformer from transformer store 180 at step 570.

At step 580, processing generates a target object using the transformer, which may use a corresponding target model that is located in target models store 190. The transformer may be a runtime object that includes metadata such as input model elements, output model elements, and additional transformer attributes. Target models store 190 is the same as that shown in FIG. 1, and may be stored on a nonvolatile storage area, such as a computer hard drive. Processing returns at 590.

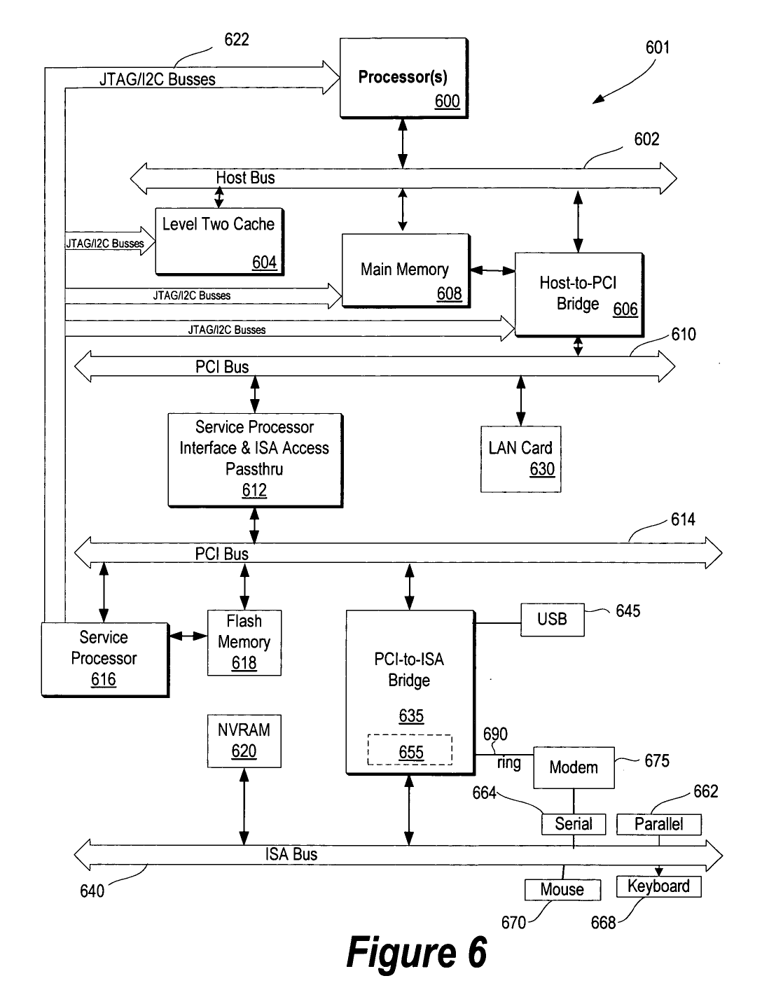

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 665 is connected to serial port 664 and PCI-to-ISA Bridge 635.

While FIG. 6 shows one information handling system that employs processor(s) 600, the information handling system may take many forms. For example, information handling system 601 may take the form of a desktop, server, portable, laptop, notebook, or other form factor computer or data processing system. Information handling system 601 may also take other form factors such as a personal digital assistant (PDA), a gaming device, ATM machine, a portable telephone device, a communication device or other devices that include a processor and memory.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving source document input from a source editor, the source document input corresponding to a source instance document;
identifying a source model element located in a nonvolatile storage device that corresponds to the source document input;
selecting a transformer that corresponds to the source model element;
generating a target object using the selected transformer and the source document input; and
inserting the generated target object into a target instance document that is displayed on a display device using a target editor.

2. The method of claim 1 further comprising:
receiving a model mapping request;
displaying a source model and a target model on the display device in response to receiving the model mapping request;
receiving model mapping input in response to the displaying; and
generating a model mapping definition based upon the model mapping input, the model mapping definition associated with the source model element and a target model element that is included in the target model.

3. The method of claim 2 further comprising:
determining whether the source document input corresponds to a new object;
retrieving the model mapping definition in response to determining that the source document input corresponds to the new object; and
creating an object mapping definition based upon the retrieved model mapping definition.

4. The method of claim 3 further comprising:
retrieving the object mapping definition in response to determining that the source document input does not correspond to the new object; and
using the object mapping definition to locate the transformer.

5. The method of claim 1 wherein the target document includes a plurality of target objects, the generated target object replacing one of the plurality of target objects.

6. The method of claim 1 wherein the source instance document is generated from a source model and the target instance document is generated from a target model, the source model including a plurality of source model elements and the target model including a plurality of target model elements.

7. The method of claim 6 wherein the generating is performed within an Eclipse Modeling Framework.

8. A computer program product stored on a computer operable media, the computer operable media containing instructions for execution by a computer, which, when executed by the computer, cause the computer to implement a method for transforming source instance document changes to target instance document changes, the method comprising:
receiving source document input from a source editor, the source document input corresponding to a source instance document;
identifying a source model element that corresponds to the source document input;
selecting a transformer that corresponds to the source model element;
generating a target object using the selected transformer and the source document input; and
inserting the generated target object into a target instance document that is displayed on a target editor.

9. The computer program product of claim 8 wherein the method further comprises:
receiving a model mapping request;
displaying a source model and a target model in response to receiving the model mapping request;
receiving model mapping input in response to the displaying; and
generating a model mapping definition based upon the model mapping input, the model mapping definition associated with the source model element and a target model element that is included in the target model.

10. The computer program product of claim 9 wherein the method further comprises:
determining whether the source document input corresponds to a new object;
retrieving the model mapping definition in response to determining that the source document input corresponds to the new object; and
creating an object mapping definition based upon the retrieved model mapping definition.

11. The computer program product of claim 10 wherein the method further comprises:
retrieving the object mapping definition in response to determining that the source document input does not correspond to the new object; and
using the object mapping definition to locate the transformer.

12. The computer program product of claim 8 wherein the target document includes a plurality of target objects, the generated target object replacing one of the plurality of target objects.

13. The computer program product of claim 8 wherein the source instance document is generated from a source model and the target instance document is generated from a target model, the source model including a plurality of source model elements and the target model including a plurality of target model elements.

14. The computer program product of claim 8 wherein the generating is performed within an Eclipse Modeling Framework.

15. An information handling system comprising:
one or more displays;
one or more processors;
a memory accessible by the processors;
one or more nonvolatile storage devices accessible by the processors; and
a transformation tool for transforming source instance document changes to target instance document changes, the transformation tool being effective to:
receive source document input from a source editor, the source document input corresponding to a source instance document;
identify a source model element located in one of the nonvolatile storage devices that corresponds to the source document input;
select a transformer located in one of the nonvolatile storage devices that corresponds to the source model element;
generate a target object using the selected transformer and the source document input; and
insert the generated target object into a target instance document that is displayed on one of the displays.

16. The information handling system of claim 15 wherein transformation tool is further effective to:
receive a model mapping request;
display a source model and a target model on one of the displays in response to receiving the model mapping request;
receive model mapping input in response to the displaying; and
generate a model mapping definition based upon the model mapping input, the model mapping definition associated with the source model element and a target model element that is included in the target model.

17. The information handling system of claim 16 wherein the transformation tool is further effective to:
determine whether the source document input corresponds to a new object;
retrieve the model mapping definition from one of the nonvolatile storage devices in response to determining that the source document input corresponds to the new object; and
create an object mapping definition based upon the retrieved model mapping definition.

18. The information handling system of claim 17 wherein the transformation tool is further effective to:
retrieve the object mapping definition from one of the nonvolatile storage devices in response to determining that the source document input does not correspond to the new object; and
use the object mapping definition to locate the transformer.

19. The information handling system of claim 15 wherein the target document includes a plurality of target objects, the generated target object replacing one of the plurality of target objects.

20. The information handling system of claim 15 wherein the source instance document is generated from a source model located in one of the nonvolatile storage devices and the target instance document is generated from a target model located in one of the nonvolatile storage devices, the source model including a plurality of source model elements and the target model including a plurality of target model elements.

21. A computer-implemented method comprising:
receiving a model mapping request;
displaying a source model and a target model in response to receiving the model mapping request;
receiving model mapping input in response to the displaying;
generating a model mapping definition based upon the model mapping input, the model mapping definition associated with a source model element included in the source model and a target model element that is included in the target model;
receiving source document input from a source editor, the source document input corresponding to a source instance document that is generated from the source model;
determining whether the source document input corresponds to a new object;
identifying the source model element that corresponds to the source document input;
retrieving the model mapping definition in response to determining that the source document input corresponds to the new object;
selecting a transformer that corresponds to the source model element;
generating a target object using the selected transformer and the source document input;
creating an object mapping definition based upon the retrieved model mapping definition; and
inserting the generated target object into a target instance document that is displayed on a target editor.
